(19) United States
(12) Patent Application Publication
(10) Pub. No.: US 2006/0194933 A1
(43) Pub. Date: Aug. 31, 2006

(54) Thermosetting epoxy resin composition and transparent material

(76) Inventors: Hideyuki Takai, Ohtake-shi (JP); Hisashi Maeshima, Hiroshima-shi (JP)

Correspondence Address: BIRCH STEWART KOLASCH & BIRCH, PO BOX 747, FALLS CHURCH, VA, 22040-0747, US

(21) Appl. No.: 10/567,253

(22) PCT Filed: Aug. 23, 2004
(86) PCT No.: PCT/JP04/12426

§ 371 Date: Feb. 6, 2006

(30) Foreign Application Priority Data
Aug. 25, 2003 (JP) 2003-300473

(51) Int. Cl. C08L 63/00; B32B 27/38

(52) U.S. Cl. 525/524

(57) ABSTRACT

A thermosetting resin composition of this invention contains 100 parts by weight of composition (E), 0.01 to 20 parts by weight of a cationic polymerization initiator (C), and, where necessary, 50 parts by weight or less of an epoxy-containing acrylic resin (D), the composition (E) contains 10 to 99 percent by weight of an ester-free alicyclic epoxy compound (A), and 90 to 1 percent by weight of an epoxy compound (B) differing from (A). A cured article thereof is excellent in heat resistance, dimensional stability, and optical transparency and can be used as a replacement for glass substrates.

### TECHNICAL FIELD

The present invention relates to thermosetting resin compositions which yield cured articles excellent in optical transparency, dimensional stability, and heat resistance and to optically transparent materials using the compositions.

### BACKGROUND ART

Display devices using liquid crystals or organic electroluminescence (organic EL) have been incorporated into mobile devices so as to reduce the sizes, thickness, and weights of the mobile devices. Glass is generally used as substrates and display components of the display devices using liquid crystals or organic EL. Any replacement for glass, however, is demanded, since glass has a high specific gravity and is susceptible to impact.

However, thermoplastic resins as the replacement are insufficient in heat resistance and optical transparency. Now-commercially-available aromatic epoxy resins are also insufficient in optical transparency of cured articles therefrom. Furthermore, nonaromatic epoxy resins are insufficient typically in heat resistance, optical transparency, and dimensional stability of cured articles therefrom, although they have relatively good optical transparency.

Japanese Unexamined Patent Application Publication (JP-A) No. 02-169620 discloses a technique of preparing an optically transparent substrate for liquid crystal panels, using a cured article of an alicyclic acid anhydride and an epoxy resin. The resulting article, however, is still insufficient in heat resistance and dimensional stability.

Accordingly, an object of the present invention is to provide a thermosetting resin composition that can yield a replacement typically for glass substrates which is excellent in heat resistance, dimensional stability, and optical transparency.

### DISCLOSURE OF INVENTION

As a result of dedicated research, the present inventors have found that the heat resistance and the dimensional stability of an epoxy resin can be increased while maintaining optical transparency by eliminating ester bonds from an alicyclic epoxy compound. The present invention has been achieved based on these findings.

Specifically, the present invention provides, in a first aspect, a thermosetting resin composition comprising 100 parts by weight of an epoxy composition (E) and 0.01 to 20 parts by weight of a cationic polymerization initiator (C), the epoxy composition (E) comprising 10 to 99 percent by weight of an ester-free alicyclic epoxy compound (A) having two alicyclic epoxy groups and no ester bond per molecule; and 90 to 1 percent by weight of another epoxy compound (B) differing from the epoxy compound (A), the total of (A) and (B) being 100 percent by weight.

The present invention further provides, in a second aspect, further comprising 50 parts by weight or less of an epoxy-containing acrylic resin (D) differing from the components (A) and (B), to 100 parts by weight of the epoxy composition (E).

In a third aspect, the present invention provides the thermosetting resin composition of the second aspect, in which the epoxy-containing acrylic resin (D) further comprises hydroxyl group in addition to epoxy group.

The present invention provides, in a fourth aspect, the thermosetting resin composition of any one of the first, second, and third aspects, in which the ester-free alicyclic epoxy compound (A) is an epoxy compound represented by Structural Formula (1): 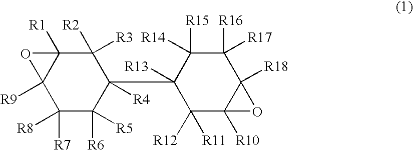
wherein R1 to R18 may be the same as or different from one another and are each hydrogen atom, a halogen atom, a hydrocarbon group which may comprise oxygen atom or a halogen atom, or a substituted or unsubstituted alkoxy group.

In a fifth aspect, the present invention provides the thermosetting resin composition of any one of the first, second, and third aspects, in which the ester-free alicyclic epoxy compound (A) is an epoxy compound represented by Structural Formula (3): 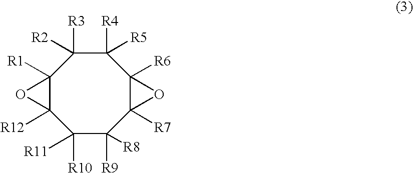
wherein R1 to R12 may be the same as or different from one another and are each hydrogen atom, a halogen atom, a hydrocarbon group which may comprise oxygen atom or a halogen atom, or a substituted or unsubstituted alkoxy group.

In a sixth aspect, the present invention provides the thermosetting resin composition of any one of the first, second, and third aspects, in which the ester-free alicyclic epoxy compound (A) is an epoxy compound represented by Structural Formula (5): 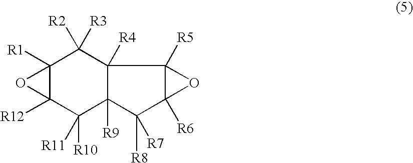
wherein R1 to R12 may be the same as or different from one another and are each hydrogen atom, a halogen atom, a hydrocarbon group which may comprise oxygen atom or a halogen atom, or a substituted or unsubstituted alkoxy group.

In addition, the present invention provides, in a seventh aspect, an optically transparent material prepared by thermally curing the thermosetting resin composition of any one of the first, second, third, fourth, fifth, and sixth aspects of the present invention.

### BEST MODE FOR CARRYING OUT THE INVENTION

The present invention will be specifically described in detail below.

Thermosetting resin compositions in the present invention are resin compositions that will undergo cationic polymerization by heating and be cured. They comprise 100 parts by weight of an epoxy composition (E) and 0.01 to 20 parts by weight of a cationic polymerization initiator (C), the epoxy composition (E) comprising 10 to 99 percent by weight of an ester-free alicyclic epoxy compound (A), and 90 to 1 percent by weight of an epoxy compound (B) differing from the epoxy compound (A), the total of (A) and (B) being 100 percent by weight; or comprise 100 parts by weight of an epoxy composition (E), 0.01 to 20 parts by weight of a cationic polymerization initiator (C), and 50 parts by weight or less of an acrylic resin (D), the epoxy composition (E) comprising 10 to 99 percent by weight of an ester-free alicyclic epoxy compound (A), and 90 to 1 percent by weight of an epoxy compound (B) differing from the epoxy compound (A), the total of (A) and (B) being 100 percent by weight, and the epoxy-containing acrylic resin (D) differing from the epoxy compounds (A) and (B).

(A) Ester-free Alicyclic Epoxy Compound (Also Referred to as the Component (A))

The ester-free alicyclic epoxy compound (A) for use in the present invention is a compound having two alicyclic epoxy groups and no ester bond per molecule, and specific examples thereof are compounds represented by following Formulae (1), (3), and (5).

In the ester-free alicyclic epoxy compounds of Formula (1), R1 to R18 may be the same as or different from one another and each represent hydrogen atom, a halogen atom, a hydrocarbon group having one to six carbon atoms which may comprise oxygen atom or a halogen atom, or a substituted or unsubstituted alkoxy group having one to six carbon atoms.

The ester-free alicyclic epoxy compounds of Formula (1) can be produced, for example, by oxidizing an unsaturated compound of following Formula (2) having a bicyclohexyl-3,3′-diene skeleton with an organic percarboxylic acid or aqueous hydrogen peroxide solution.

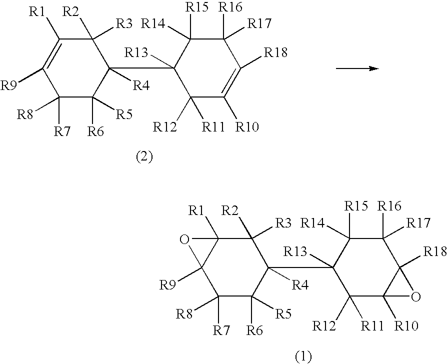

In the ester-free alicyclic epoxy compounds represented by Formula (3), R1 to R12 may be the same as or different from one another and each represent hydrogen atom, a halogen atom, a hydrocarbon group having one to six carbon atoms which may comprise oxygen atom or a halogen atom, or a substituted or unsubstituted alkoxy group having one to six carbon atoms.

The ester-free alicyclic epoxy compounds of Formula (3) can be produced, for example, by oxidizing an unsaturated compound of following Formula (4) having a cyclooctadiene skeleton with an organic percarboxylic acid or aqueous hydrogen peroxide solution.

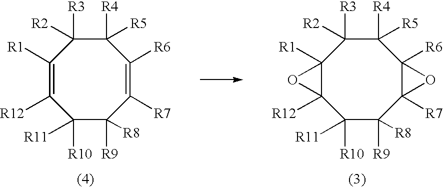

In the ester-free alicyclic epoxy compounds represented by Formula (5), R1 to R12 may be the same as or different from one another and each represent hydrogen atom, a halogen atom, a hydrocarbon group having one to six carbon atoms which may comprise oxygen atom or a halogen atom, or a substituted or unsubstituted alkoxy group having one to six carbon atoms.

The ester-free alicyclic epoxy compounds of Formula (5) can be produced, for example, by oxidizing an unsaturated compound of following Formula (6) having an alicyclic indene skeleton with an organic percarboxylic acid or aqueous hydrogen peroxide solution. 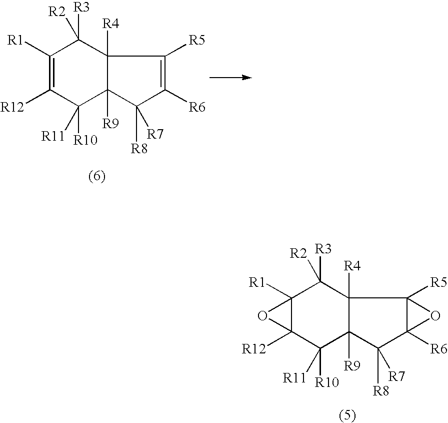
(B) Epoxy Compound Differing from (A) (Also Referred to as the Component (B))

The epoxy compound (B) differing from the epoxy compound (A) for use in the present invention is a compound having one or more, preferably one or two, epoxy groups per molecule. These epoxy groups can be any of alicyclic epoxy groups and other epoxy groups than alicyclic epoxy groups.

Specific examples of the compound having one or more alicyclic epoxy groups per molecule as the component (B) are dicyclopentadiene diepoxide, limonene diepoxide, di(3,4-epoxycyclohexyl) adipate, (3,4-epoxycyclohexyl)methyl 3′,4′-epoxycyclohexanecarboxylate, (3,4-epoxy-6-methylcyclohexyl)methyl 3′,4′-epoxy-6¹-methylcyclohexanecarboxylate, ethylene-1,2-di(3,4-epoxycyclohexylcarboxylate), and 3,4-epoxycyclohexylethyltrimethoxysilane. Among them, 3,4-epoxycyclohexylmethyl 3′,4′-epoxycyclohexanecarboxylate, 3,4-epoxycyclohexylmethyl alcohol, and 3,4-epoxycyclohexylethyltrimethoxysilane are preferred. Each of these compounds can be used alone or in combination. An ester-containing alicyclic epoxy compound can be used as the component (B).

When the proportion of the component (A) as the ester-free alicyclic epoxy compound is large, the optical transparency can be maintained even if an ester-containing alicyclic epoxy compound is used as the component (B).

However, the content of a compound or compounds having an ester bond in the epoxy composition (E) should be less than 50 percent by weight.

Examples of compounds having at least one epoxy group per molecule other than alicyclic epoxy group as the component (B) include bisphenol diglycidyl ethers typified by bisphenol-A and bisphenol-F diglycidyl ethers (e.g., commercially available products such as Epikote 828 and 806 from Japan Epoxy Resins Co., Ltd.; and YD-128 from Tohto Kasei Co., Ltd.), and hydrogenated bisphenol epoxy resins (e.g., commercially available products such as HBE-100 from New Japan Chemical Co., Ltd.; YX-4000 from Japan Epoxy Resins Co., Ltd.; and YX-8000 from Japan Epoxy Resins Co., Ltd.). Other examples thereof are glycidyl ethers having a cyclic aliphatic skeleton, such as diglycidyl ether of cyclohexanedimethanol, (e.g., commercially available products such as DME-100 from New Japan Chemical Co., Ltd.); glycidyl ethers of novolac phenol resins; glycidyl ethers of copolymerized novolac phenol resins typically with DCPD (dicyclopentadiene); glycidyl ethers of polycyclic aromatic compounds such as naphthalene; epoxy resins having a terminal epoxy in an alicyclic skeleton (e.g., commercially available products such as EHPE-3150 and EHPE-3150CE from Daicel Chemical Industries, Ltd.); and silicone resins having epoxy group (e.g., commercially available products such as A-186 from Nippon Unicar Co., Ltd., and KBM 303, KBM 403, and KBM 42 from Shin-Etsu Chemical Co., Ltd.).

(D) Epoxy-Containing Acrylic Resin (Also Referred to as the Component (D))

The epoxy-containing acrylic resin (D) for use in the present invention is an acrylic resin which may have, where necessary, one or more hydroxyl groups in addition to epoxy groups. It can be prepared by polymerizing an epoxy-containing monomer or by copolymerizing an epoxy-containing monomer and a hydroxy-containing monomer and is another epoxy compound than the components (A) and (B).

The epoxy-containing monomer includes compounds each having a glycidyl group or a terminal epoxy group analogous thereto; and (meth)acrylic esters typically having an alicyclic epoxy. Specific examples thereof are glycidyl (meth)acrylate, 2-methyl-glycidyl(meth)acrylate, epoxidized isoprenyl(meth)acrylate, and epoxy-containing (meth)acrylates CYM M-100 and CYM A-200 available from Daicel Chemical Industries, Ltd. having the following structural formulae.

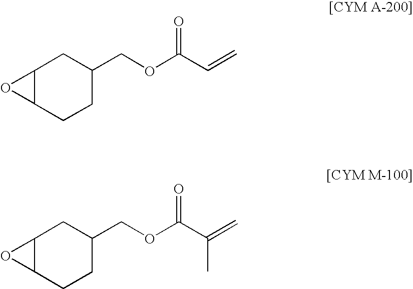

The hydroxy-containing monomer includes hydroxyethyl (meth)acrylate, and monomers prepared by modifying hydroxyl groups of these hydroxy-containing (meth)acrylates with caprolactone. The modified monomers are commercially available under the trade names of FM-1, FM-3, FM-10, FA-1, and FA-3 from Daicel Chemical Industries, Ltd.

Regular alkyl(meth)acrylate monomers can be used as monomers for the epoxy-containing acrylic resin (D), in addition to the epoxy-containing monomer and the hydroxy-containing monomer.

Examples of regular alkyl(meth)acrylate monomers are (meth)acrylic acid esters of alkyls or cycloalkyls each having one to twenty-four carbon atoms, such as methyl (meth)acrylate, ethyl(meth)acrylate, n-, i-, or t-butyl (meth)acrylate, hexyl(meth)acrylate, octyl(meth)acrylate, lauryl(meth)acrylate, stearyl(meth)acrylate, and cyclohexyl(meth)acrylate; (meth)acrylic esters of hydroxyalkyls each having one to eight carbon atoms, such as 2-hydroxyethyl(meth)acrylate, 2-hydroxypropyl (meth)acrylate, and 4-hydroxybutyl(meth)acrylate; α,β-ethylenically unsaturated carboxylic acids such as (meth)acrylic acids, maleic acid, itaconic acid, and crotonic acid; (meth)acrylamides and derivatives thereof, such as (meth)acrylamides, N-methyl(meth)acrylamides, N-ethyl(meth)acrylamides, diacetone(meth)acrylamides, N-methylol(meth)acrylamides, N-methoxy(meth)acrylamides, and N-butoxy(meth)acrylamides; aromatic vinyl monomers, such as styrene, vinyltoluene, and α-methylstyrene; vinyl propionate, vinyl acetate, (meth)acrylonitrile, vinyl pivalate, VEOVA monomer (available from Shell Chemical Co., Ltd.; vinyl ester of a branched fatty acid), SILAPLANE FM 0711, SILAPLANE FM 0721, and SILAPLANE FM 0725 (each available from Chisso Corporation; polydimethylsiloxane macro monomers having a terminal methacryloyl group), and other vinyl monomers.

A polymerization initiator can be used to produce the epoxy-containing acrylic resin (D) from the above-mentioned monomers. The polymerization initiator can be, for example, any of potassium persulfate, ammonium persulfate, benzoyl peroxide, hydrogen peroxide, di-t-butyl peroxide, dicumyl peroxide, 2,4-dichlorobenzoyl peroxide, decanoyl peroxide, lauryl peroxide, cumene hydroperoxide, t-butyl hydroperoxide, acetyl peroxide, methyl ethyl ketone peroxide, succinic peroxide, diacetyl peroxydicarbonate, t-butyl peroxyacetate, AIBN (2,2′-azobisisobutyronitrile), ABN-E (2,2′-azobis(2-methylbutyronitrile)), ABN-V (2,2′-azobis(2,4-dimethylvaleronitrile)), and Perbutyl O (t-butyl peroxy-2-ethylhexanoate).

The amount of the polymerization initiator is 1 to 10 parts by weight, and preferably 3 to 6 parts by weight, to 100 parts by weight of the monomers. Part of the polymerization initiator may be charged into a reactor beforehand. Alternatively, the polymerization initiator can be incorporated into the monomers, fed separately without incorporating into the monomers, or subsequently fed after the charging of the monomers.

The polymerization temperature is 90° C. to 130° C., and preferably 100° C. to 120° C. If the temperature exceeds 130° C., the polymerization may become unstable and yield large amounts of high molecular weight compounds. In contrast, if it is lower than 90° C., the polymerization time may become unfavorably long.

The epoxy group content of the epoxy-containing acrylic resin (D) is 4% to 12%, and preferably 5.5% to 11.5% in terms of oxirane oxygen content. The amount of hydroxyl groups in the acrylic resin having hydroxyl groups in addition to epoxy groups is preferably within the range of 1 to 300 (unit: mg-KOH/g) and more preferably within the range of 1.5 to 250 (unit: mg-KOH/g) in terms of hydroxyl value.

(C) Cationic Polymerization Initiator (Also Referred to as the Component (C))

The cationic polymerization initiator (C) for use in the present invention is a compound that forms cation species as a result of heating so as to initiate the polymerization. Examples thereof are cationic polymerization initiators such as hexafluoroantimonate salts, pentafluorohydroxyantimonate salts, hexafluorophosphate salts, and hexafluoroarsenate salts represented by following Formulae (I) to (XV):
Ar₂I+·X⁻ (I)
Ar₃S+·X⁻ (II)
wherein Ar represents an aryl group such as phenyl group; and X⁻ represents PF₆⁻, SbF₆⁻, or AsF₆⁻, 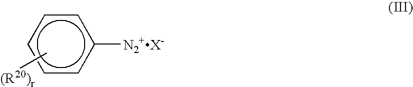
wherein R20 represents an alkyl or alkoxy group having one to twelve carbon atoms; r represents an integer of 0 to 3; and X⁻ represents PF₆⁻, SbF₆⁻, or AsF₆⁻, 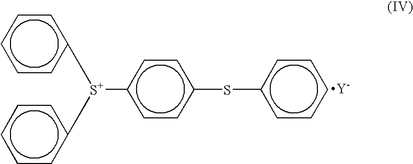
wherein Y⁻ represents PF₆⁻, SbF₆⁻, AsF₆⁻, or SbF₅(OH)⁻, 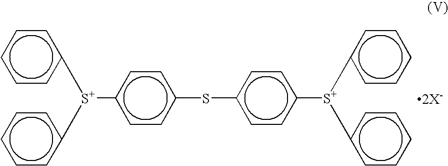
wherein X⁻ represents PF₆⁻, SbF₆⁻, or AsF₆⁻, 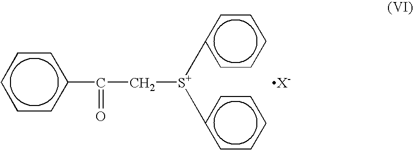
wherein X⁻ represents PF₆⁻, SbF₆⁻, or AsF₆⁻, 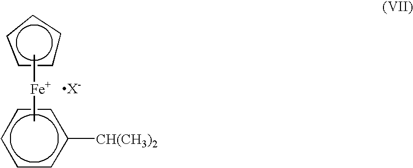
wherein X⁻ represents PF₆⁻, SbF₆⁻, or AsF₆⁻, 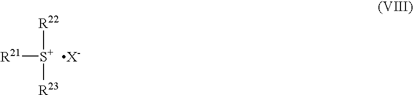
wherein R21 represents an aralkyl group having seven to fifteen carbon atoms or an alkenyl group having three to nine carbon atoms; R22 represents a hydrocarbon group having one to seven carbon atoms or hydroxyphenyl group; R23 represents an alkyl group having one to five carbon atoms which may contain oxygen atom or sulfur atom; and X⁻ represents PF₆⁻, SbF₆⁻, or AsF₆⁻, 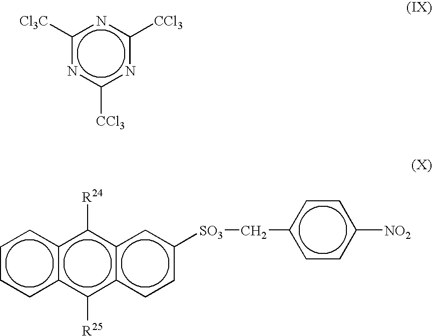
wherein R24 and R25 each independently represent an alkyl or alkoxy group having one to twelve carbon atoms, 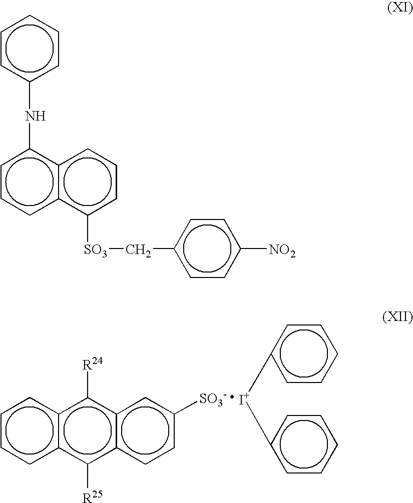
wherein R24 and R25 each independently represent an alkyl or alkoxy group having one to twelve carbon atoms, 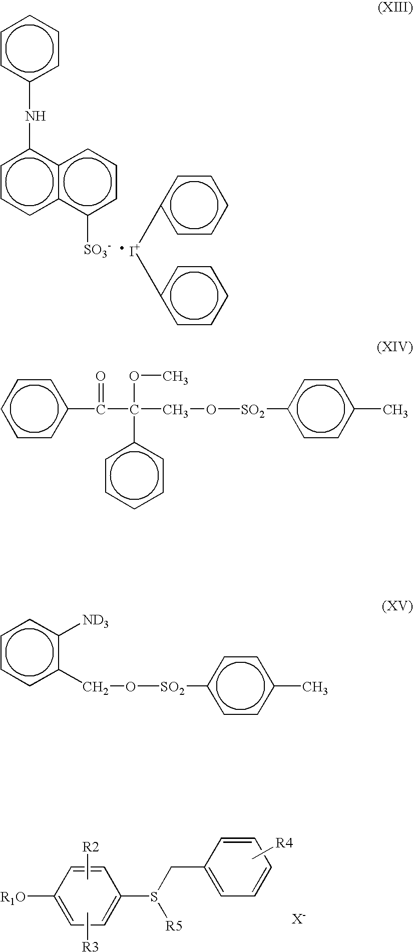
wherein R1 represents one of hydrogen atom, COCH₃ group, and COOCH₃ group; each of R2 and R3 represents one of hydrogen atom, a halogen, and an alkyl group having one to four carbon atoms; R4 represents one of hydrogen atom, methyl group, methoxy group, and a halogen atom; R5 represents an alkyl group having one to four carbon atoms; and X⁻ represents one of SbF₆⁻, AsF₆⁻, PF₆^{-, and BF}₄⁻, 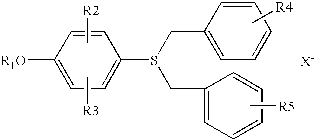
wherein R1 represents one of hydrogen atom, acetyl group, methoxycarbonyl group, methyl, epoxycarbonyl group, t-butoxycarbonyl group, benzoyl group, phenoxycarbonyl group, benzyloxycarbonyl group, 9-fluorenylmethoxycarbonyl group, and p-methoxybenzylcarbonyl group; each of R2 and R3 represents one of hydrogen atom, a halogen atom, and an alkyl group having one to four carbon atoms; each of R4 and R5 represents one of hydrogen atom, methyl group, methoxy group, and a halogen atom; and X⁻ represents one of SbF₆⁻, AsF₆⁻, PF₆⁻, and BF₄⁻, 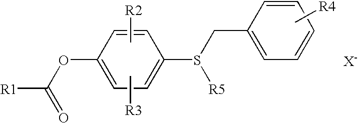
wherein R1 represents one of ethoxy group, phenyl group, phenoxy group, benzyloxy group, chloromethyl group, dichloromethyl group, trichloromethyl group, and trifluoromethyl group; each of R2 and R3 represents one of hydrogen atom, a halogen atom, and an alkyl group having one to four carbon atoms; R4 represents one of hydrogen, methyl group, methoxy group, and a halogen atom; R5 represents one of alkyl groups each having one to four carbon atoms; and X⁻ represents one of SbF₆⁻, AsF₆⁻, PF₆⁻, and BF₄⁻, 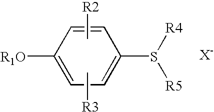
wherein R1 represents one of hydrogen atom, acetyl group, methoxycarbonyl group, methyl group, epoxycarbonyl group, t-butoxycarbonyl group, benzoyl group, phenoxycarbonyl group, benzyloxycarbonyl group, 9-fluorenylmethoxycarbonyl group, and p-methoxybenzylcarbonyl group; each of R2 and R3 represents one of hydrogen atom, a halogen atom, and an alkyl group having one to four carbon atoms; each of R4 and R5 represents one of methyl group and ethyl group; and X⁻ represents one of SbF₆⁻, AsF₆⁻, and PF₆⁻.

The cationic polymerization initiator (C) can be a commercially available product. Examples of the commercially available product are sulfonium salt cationic polymerization initiators available under the trade names of SI-100L and SI-60L from Sanshin Chemical Industry Co., Ltd., and CP-66 from Asahi Denka Kogyo K.K.

Apart from these cationic polymerization initiators, a combination of a chelate compound of aluminum or titanium with a beta-diketone and a silanol-containing compound or bisphenol-S can be used. The beta-diketone to coordinate with aluminum or titanium includes acetylacetone and acetoacetic esters. Examples of these chelate compounds are aluminum trisethylacetoacetate (available under the trade name of ALCH-TR from Kawaken Fine Chemicals Co., Ltd.) and aluminum trisacetylacetonate.

The thermosetting resin compositions of the present invention may further comprise any of pigments such as coloring pigments and extender pigments, polyol resins, phenol resins, acrylic resins, polyester resins, polyolefin resins, epoxidized polybutadiene resins and other modified resins, inorganic or organic resin fine particles, solvents, and dyestuffs, in addition to the components (A), (B), and (C), and the component (D) which is added according to necessity.

The content of the modified resins is 0.1 to 20 parts by weight, and preferably 5 to 10 parts by weight, to 100 parts by weight of the epoxy composition (E).

The thermosetting resin compositions of the present invention can be prepared according to a conventional procedure. For example, they can be prepared by stirring the above-mentioned components to be homogenous using a stirrer such as dissolver. The temperature upon stirring is preferably within the range of 10° C. to 60° C.

The epoxy composition (E) for use in the present invention comprises 10 to 99 percent by weight, preferably 30 to 98 percent by weight, and more preferably 50 to 97 percent by weight of the component (A), and 90 to 1 percent by weight, preferably 70 to 2 percent by weight, and more preferably 50 to 3 percent by weight of the component (B). If the content of the component (A) is less than 10 percent by weight, the resulting cured article deteriorates in optical transparency and toughness. In contrast, if the content of the component (A) exceeds 99 percent by weight, it is economically unfavorable.

The proportion of the component (C) in the thermosetting resin compositions of the present invention is 0.01 to 20 parts by weight, preferably 0.1 to 10 parts by weight, and more preferably 1 to 5 parts by weight, to 100 parts by weight of the epoxy composition (E).

The thermosetting resin compositions of the present invention, in a second embodiment, further comprise the component (D) relative to 100 parts by weight of the epoxy composition (E). Addition of the component (D) further improves the optical transparency and toughness of the cured article. The amount of the component (D) is 1 to 50 parts by weight, preferably 2 to 30 parts by weight, and more preferably 5 to 20 parts by weight, to 100 parts by weight of the epoxy composition (E). If the amount of the component (D) is less than 1 part by weight, the effect of adding the component (D) may not be exerted. In contrast, if the amount of the component (D) exceeds 50 parts by weight, the resulting cured article may have decreased dimensional stability and heat resistance.

The thermosetting resin compositions of the present invention can be cured by heating at temperatures of 40° C. to 250° C., and preferably 45° C. to 240° C., for 3 to 12 hours.

### EXAMPLES

The present invention will be specifically described with reference to several examples below, but it is not to be construed as being limited thereto.

All percentages and parts are by weight, unless otherwise specified.

### Synthesis Example 1

### (A) Synthesis of Ester-Free Alicyclic Epoxy Compound A-1

In a reactor were placed 406 g of bicyclohexyl-3,3′-diene, an example of the compounds of Formula (2), and 1217 g of ethyl acetate. While passing nitrogen gas through the gas phase and keeping the inner temperature of the reactor to 37.5° C., 457 g of a 30 percent by weight solution of peroxyacetic acid in ethyl acetate (moisture content: 0.41 percent by weight) was added dropwise over about 3 hours. After the completion of dropwise addition, the mixture was stirred at 40° C. for one hour and the epoxidation completed. Next, the reactor was cooled to 30° C., and the crude reaction mixture was washed with water. Subsequently, low boiling components were removed from the crude reaction mixture at 70° C. and 20 mmHg (2660 Pa) to yield 415 g of an epoxy compound (bicyclohexyl-3,4,3′,4′-diepoxide). The obtained epoxy compound is hereinbelow referred to as A-1. A-1 has an oxirane oxygen content of 14.7 percent by weight and was obtained in a yield of 85%.

¹H-NMR analysis of A-1 revealed that a peak derived from internal double bond at δ of around 4.5 to δ ppm disappeared, and that a proton peak derived from epoxy group formed at 6 of around 2.9 to 3.1 ppm, verifying that A-1 is an ester-free alicyclic epoxy compound having the structure of Formula (1).

### Synthesis Example 2

### (A) Synthesis of Ester-Free Alicyclic Epoxy Compound A-2

In a reactor were placed 108 g of cyclooctadiene, an example of the compounds of Formula (4), and 108 g of ethyl acetate. While passing nitrogen gas through the gas phase and keeping the inner temperature of the reactor to 30° C., 532 g of a 30 percent by weight solution of peroxyacetic acid in ethyl acetate (moisture content: 0.41 percent by weight) was added dropwise over about 3 hours. After the completion of dropwise addition, the mixture was stirred at 30° C. for 5 hours and the epoxidation completed. Next, the reactor was cooled to 20° C., 86.9 g of sodium carbonate was added to the stirred crude reaction mixture, 219 g of a 10% aqueous NaOH solution was further added, the reaction mixture was left stand, and the lower aqueous phase was extracted. After repeating this procedure three times, residual neutralized salts were washed twice by adding 250 g of deionized water to the residual organic phase. Subsequently, low boiling components were removed from the crude reaction mixture at 60° C. and 20 mmHg (2660 Pa) to yield 112.3 g of a diepoxy compound (cyclooctane-1,2,5,6-diepoxide). The obtained epoxy compound is referred to as A-2. The yield of A-2 is 80.2%.

### Synthesis Example 3

### (A) Synthesis of Ester-Free Alicyclic Epoxy Compound A-3

In a reactor were placed 240 g of 3a,4,7,7a-tetrahydroindene, an example of the compounds of Formula (6), and 480 g of ethyl acetate. While passing nitrogen gas through the gas phase and keeping the inner temperature of the reactor to 30° C., 1220 g of a 30 percent by weight solution of peroxyacetic acid in ethyl acetate (moisture content: 0.41 percent by weight) was added dropwise over about 3 hours. After the completion of dropwise addition, the mixture was stirred at 30° C. for 6 hours and the epoxidation completed. Next, the reactor was cooled to 20° C., 398 g of sodium carbonate was added to the stirred crude reaction mixture, 1500 g of a 10% aqueous NaOH solution was further added, the reaction mixture was left stand, and the lower aqueous phase was extracted. Residual neutralized salts were washed out by adding 1000 g of deionized water to the residual organic phase. Subsequently, low boiling components were removed from the crude reaction mixture at 40° C. and 10 mmHg (1330 Pa) to yield 243 g of a diepoxy compound (a diepoxy compound of 3a,4,7,7a-tetrahydroindene). The obtained epoxy compound is referred to as A-3. The yield of A-3 is 80%.

### Synthesis Examples 4 and 5

### Synthesis of Epoxy-Containing Acrylic Resin (D)

An aliquot of 3,4-epoxycyclohexylmethyl 3′,4′-epoxycyclohexanecarboxylate (trade name: CEL-2021) (233 g) in Table 1 was placed in a flask equipped with a stirrer, a reflux condenser, a dropping funnel, and a thermometer. The temperature was raised to 105° C. to 110° C. while blowing air thereinto, and the monomer and the initiator in Table 1 were added dropwise over 3 hours. After the completion of dropwise addition, the mixture was stirred for one hour, and the reaction completed.

The acrylic resins D-1 and D-2 obtained in SYNTHESIS EXAMPLES 4 and 5, respectively, have hydroxyl groups in addition to epoxy groups.

TABLE 1

| | | | SYNTHESIS | SYNTHESIS |
|---|---|---|---|---|
| Synthesis of Component (D) | | | EXAMPLE 4 | EXAMPLE 5 |
| Monomer | Alicyclic epoxy resin | CEL-2021 (g) | 233 | 233 |
| | Acrylic monomer | MMA (g) | 55 | 65 |
| | | n-BMA (g) | 15 | 10 |
| | | HEMA (g) | 20 | 15 |
| | | CYM M-100 (g) | 10 | |
| | | GMA (g) | | 10 |

| | | | |
|---|---|---|---|
| Polymerization initiator | AIBN (g) | 3 | 3 |
| Polymerization inhibitor | MEHQ (g) | 0.3 | 0.3 |
| Component (D) | | D-1 | D-2 |
| Analytical data | Hydroxyl value | 23.6 | 18.3 |
| | (mg-KOH/g) | | |
| | Oxirane oxygen | 8.0 | 8.5 |
| | content (wt. %) | | |

MMA: Methyl methacrylate
n-BMA: n-Butyl methacrylate
HEMA: Hydroxyethyl methacrylate
GMA: Glycidyl methacrylate
AIBN: Azobisisobutyronitrile
MEHQ: p-Methoxyphenol

### Examples 1 to 11 and Comparative Examples 1 to 3

A series of thermosetting resin compositions was prepared by placing the individual components shown in Tables 2 and 3 in a 500-ml flask equipped with a stirrer and a thermometer, followed by stirring at 30° C. for 20 minutes. The resulting thermosetting resin compositions were poured into a Teflon (registered trademark) molding form 1 mm deep on a glass plate coated with a mold releasing film, and another glass plate coated with a mold releasing film was placed thereon. The resin compositions were cured under the following conditions to yield test pieces.

In EXAMPLES 1, 3, 4, 6, 7, 8, and 9, and COMPARATIVE EXAMPLES 1 and 2, the resin compositions were cured by heating at 50° C. for 4 hours and further heating at 180° C. for 2 hours.

In EXAMPLES 2, 5, 10, and 11, and COMPARATIVE EXAMPLE 3, the resin compositions were cured by heating at 70° C. for 3 hours and further heating at 180° C. for 2 hours.

The glass transition point, thermal decomposition temperature, dimensional stability, and optical transparency of the thus-obtained cured test pieces were determined. The results are shown in Tables 2 and 3.

The determination and evaluation methods used in the examples and comparative examples are shown below.

Determination of glass transition point: The determination was performed under a load of 50 g at a rate of temperature rise of 5° C./min using TMA SS6100 (Seiko Instruments, Inc.).

Determination of thermal decomposition temperature: The thermal decomposition temperature was determined using TG-DTA. The temperature at which 3% weight loss was obtained was defined as the thermal decomposition temperature.

Determination of coefficient of cubic expansion as dimensional stability: The specific gravity of a sample resin composition was determined with a pycnometer, and the specific gravity of a sample test piece as a cured article was determined by the underwater replacement method. The coefficient of cubic expansion was determined by calculation according to the following equation. The dimensional stability upon curing is better with the coefficient of cubic expansion approaching zero.
{1-[(Specific gravity of cured article)/(Specific gravity of composition)]}×100 (%)

Determination of optical transparency: The transmittance at 450 nm was measured using a transmissometer.

TABLE 2
(Components (A) to (D): Unit: g)

| | | EXAMPLE | | | | | | | COM. EX. |
|---|---|---|---|---|---|---|---|---|---|
| Component | | 1 | 2 | 3 | 4 | 5 | 6 | 7 | 1 |
| (A) | A-1 | 80 | 75 | 97 | 65 | 50 | | | |
| | A-2 | | | | | | 50 | | |
| | A-3 | | | | | | | 50 | |
| (B) | CEL-2021P | 15 | 15 | 3 | 30 | 30 | 40 | 45 | 60 |
| | EHPE-3150 | 5 | | | | 20 | | | |
| (C) | SI-60L | 0.6 | | 0.6 | 0.6 | | 0.8 | 0.6 | 0.8 |
| | ALCH-TR | | 0.2 | | | 0.15 | | | |
| | Bisphenol-S | | 0.2 | | | 0.15 | | | |
| (D) | D-1 | | 10 | | | | | 10 | 40 |
| | D-2 | | | | 5 | | 10 | | |

| | | | | | | | | |
|---|---|---|---|---|---|---|---|---|
| Glass transition point (° C.) | 256 | 222 | 275 | 208 | 194 | 179 | 186 | 161 |
| Thermal decomposition | 245 | 233 | 256 | 219 | 210 | 197 | 206 | 188 |
| temperature (° C.) | | | | | | | | |
| Coefficient of cubic | −0.85 | −1.36 | −0.06 | −1.92 | −2.02 | −2.37 | −2.18 | −3.79 |
| expansion (%) | | | | | | | | |
| Optical transparency (%) | 89.5 | 88.3 | 90.5 | 93.1 | 92.9 | 94.0 | 85.6 | 96.3 |

TABLE 3
(Components (A) to (C): Unit: g)

| | | EXAMPLE | | | | COM. EX. | |
|---|---|---|---|---|---|---|---|
| Component | | 8 | 9 | 10 | 11 | 2 | 3 |
| (A) | A-1 | 60 | 20 | 30 | | | |
| | A-2 | | | | 50 | | |
| (B) | CEL-2021P | | | 40 | 25 | | 50 |
| | EHPE-3150 | 20 | 40 | 30 | 25 | 50 | |
| | HBE-100 | | | | | 50 | 50 |
| | DME-100 | 20 | 40 | | | | |
| (C) | SI-100L | 0.6 | 0.5 | | | 0.6 | |
| | ALCH-TR | | | 0.2 | 0.25 | | 0.2 |
| | Bisphenol-S | | | 0.2 | 0.25 | | 0.2 |

| | | | | | | |
|---|---|---|---|---|---|---|
| Glass transition point (° C.) | 211 | 189 | 192 | 181 | 190 | 143 |
| Thermal decomposition | 231 | 202 | 210 | 221 | 207 | 178 |
| temperature (° C.) | | | | | | |
| Coefficient of cubic | −1.01 | −1.79 | −1.83 | −2.08 | −3.14 | −4.63 |
| expansion (%) | | | | | | |
| Optical transparency (%) | 89.9 | 91.2 | 94.5 | 86.2 | 92.3 | 83.2 |

### INDUSTRIAL APPLICABILITY

The thermosetting resin compositions of the present invention can be efficiently cured in the presence of a cationic polymerization initiator to yield cured articles which are excellent in optical transparency, heat resistance, and dimensional stability.

1. A thermosetting resin composition comprising 100 parts by weight of an epoxy composition (E) and 0.01 to 20 parts by weight of a cationic polymerization initiator (C), the epoxy composition (E) comprising 10 to 99 percent by weight of an ester-free alicyclic epoxy compound (A) having two alicyclic epoxy groups and no ester bond per molecule; and 90 to 1 percent by weight of another epoxy compound (B) differing from the epoxy compound (A), the total of (A) and (B) being 100 percent by weight.

2. The thermosetting resin composition of claim 1, further comprising 50 parts by weight or less of an epoxy-containing acrylic resin (D) differing from the components (A) and (B), to 100 parts by weight of the epoxy composition (E).

3. The thermosetting resin composition of claim 2, wherein the epoxy-containing acrylic resin (D) further comprises hydroxyl group in addition to epoxy group.

4. The thermosetting resin composition of any one of claims 1 to 3, wherein the ester-free alicyclic epoxy compound (A) is an epoxy compound represented by Structural Formula (1): 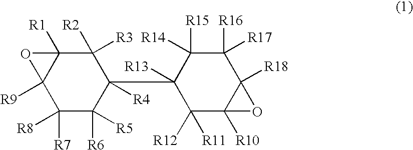
wherein R1, R2, R3, R4, R5, R6, R7, R8, R9, R10, R1, R12, R13, R14, R15, R16, R17, and R18 may be the same as or different from one another and are each hydrogen atom, a halogen atom, a hydrocarbon group which may comprise oxygen atom or a halogen atom, or a substituted or unsubstituted alkoxy group.

5. The thermosetting resin composition of any one of claims 1 to 3, wherein the ester-free alicyclic epoxy compound (A) is an epoxy compound represented by Structural Formula (3): 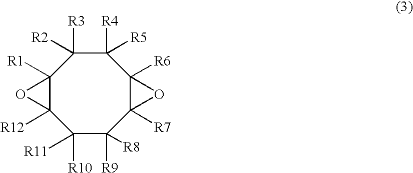
wherein R1, R2, R3, R4, R5, R6, R7, R8, R9, R10, R1, and R12 may be the same as or different from one another and are each hydrogen atom, a halogen atom, a hydrocarbon group which may comprise oxygen atom or a halogen atom, or a substituted or unsubstituted alkoxy group.

6. The thermosetting resin composition of any one of claims 1 to 3, wherein the ester-free alicyclic epoxy compound (A) is an epoxy compound represented by Structural Formula (5): 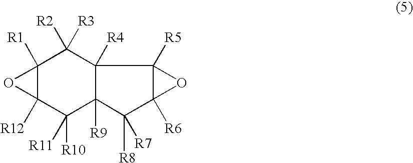
wherein R1, R2, R3, R4, R5, R6, R7, R8, R9, R10, R11, and R12 may be the same as or different from one another and are each hydrogen atom, a halogen atom, a hydrocarbon group which may comprise oxygen atom or a halogen atom, or a substituted or unsubstituted alkoxy group.

7. An optically transparent material prepared by thermally curing the thermosetting resin composition of claim 1.
